(19) United States
(12) Patent Application Publication
(10) Pub. No.: US 2026/0216759 A1
(43) Pub. Date: Jul. 30, 2026

(54) SYSTEM AND METHOD FOR REMOVING DUST FROM A VEHICLE TOUCHSCREEN

(71) Applicant: Honda Motor Co., Ltd., Tokyo (JP)

(72) Inventor: Steven FEIT, Dublin, OH (US)

(21) Appl. No.: 19/038,986

(22) Filed: Jan. 28, 2025

(51) Int. Cl. B08B 6/00; B60R 21/015

(52) U.S. Cl. CPC B08B 6/00; B60R 21/01516; B60R 21/01538

(57) ABSTRACT

A system for removing dust from a touchscreen of a vehicle is provided. The system includes the touchscreen and a dust controller. The touchscreen includes at least one panel having a driving circuit and a sensing circuit, and a cover covering the at least one panel. The dust controller is operably connected to the touchscreen for applying a first voltage signal having a first polarity to at least one of the driving circuit and the sensing circuit for ionizing dust on the cover of the touchscreen, and then applying a second voltage signal having a second polarity opposite of the first polarity to at least one of the driving circuit and the sensing circuit to repel the ionized dust from the cover.

### BACKGROUND

Generally, vehicles may be equipped with displays, such as center console displays, touchscreen displays, or other displays. One or more of these displays may be utilized as a user interface to render information for a driver, passenger, or other occupant of a vehicle. One problem with touchscreen displays is the materials used for a cover of the touchscreen attracts dust due to static build up on the cover material. Current methods to deal with dust accumulation are applying different coatings to the cover and/or using a cleaning cloth to wipe away the dust.

### BRIEF DESCRIPTION

According to one aspect, a system for removing dust from a touchscreen of a vehicle is provided. The system comprises the touchscreen and a dust controller. The touchscreen includes at least one panel having a driving circuit and a sensing circuit, and a cover covering the at least one panel. The dust controller is operably connected to the touchscreen for applying a first voltage signal having a first polarity to at least one of the driving circuit and the sensing circuit for ionizing dust on the cover of the touchscreen, and then applying a second voltage signal having a second polarity opposite of the first polarity to at least one of the driving circuit and the sensing circuit to repel the ionized dust from the cover.

According to another aspect, a system for removing dust from a touchscreen of a vehicle is provided. The system comprises the touchscreen, a dust controller, an occupant detector, and a controller. The touchscreen includes at least one panel having a driving circuit and a sensing circuit, and a cover covering the at least one panel. The dust controller is operably connected to the touchscreen for applying a first voltage signal having a first polarity to at least one of the driving circuit and the sensing circuit for ionizing dust on the cover of the touchscreen, and then applying a second voltage signal having a second polarity opposite of the first polarity to at least one of the driving circuit and the sensing circuit to repel the ionized dust from the cover. The occupant detector determines whether an occupant is within the vehicle. The controller is in communication with the dust controller and the occupant detector. The controller disables the dust controller upon detection by the occupant detector of an occupant within the vehicle.

According to another aspect, a method of removing dust from a touchscreen of a vehicle is provided. The touchscreen includes at least one panel having a driving circuit and a sensing circuit, and a cover covering the at least one panel. The method comprises determining whether an occupant is within the vehicle; and if it is determined that an occupant is not within the vehicle, applying a first voltage signal having a first polarity to at least one of the driving circuit and the sensing circuit for ionizing dust on the cover of the touchscreen, and then applying a second voltage signal having a second polarity opposite of the first polarity to at least one of the driving circuit and the sensing circuit to repel the ionized dust from the cover.

### BRIEF DESCRIPTION OF THE DRAWINGS

FIG. 1 is a schematic view of a vehicle.

FIG. 2 is an illustrative view of an environment of a system for removing dust from a touchscreen of a vehicle.

FIG. 3 is an exploded perspective view of a known touchscreen.

FIG. 4 is an enlarged partial view of part of the touchscreen of FIG. 3.

FIG. 5 is an illustrative process flow diagram of a method of removing dust from a touchscreen of a vehicle.

### DETAILED DESCRIPTION

It should, of course, be understood that the description and drawings herein are merely illustrative and that various modifications and changes may be made in the structures disclosed without departing from the present disclosure.

### DEFINITIONS

The following includes definitions of selected terms employed herein. The definitions include various examples and/or forms of components that fall within the scope of a term and that may be used for implementation. The examples are not intended to be limiting. Further, one having ordinary skill in the art will appreciate that the components discussed herein, may be combined, omitted, or organized with other components or organized into different architectures.

A “controller”, as used herein, includes, but is not limited to, a device that can be implemented in hardware, firmware, software, or a combination of the three, and includes at least one of “processor”, “module” and/or “detector”.

A “processor”, as used herein, processes signals and performs general computing and arithmetic functions. Signals processed by the processor may include digital signals, data signals, computer instructions, processor instructions, messages, a bit, a bit stream, or other means that may be received, transmitted, and/or detected. Generally, the processor may be a variety of various processors including multiple single and multicore processors and co-processors and other multiple single and multicore processor and co-processor architectures. The processor may include various modules to execute various functions.

A “memory”, as used herein, may include volatile memory and/or non-volatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory may store an operating system that controls or allocates resources of a computing device.

A “bus”, as used herein, refers to an interconnected architecture that is operably connected to other computer components inside a computer or between computers. The bus may transfer data between the computer components. The bus may be a memory bus, a memory controller, a peripheral bus, an external bus, a crossbar switch, and/or a local bus, among others. The bus may also be a vehicle bus that interconnects components inside a vehicle using protocols such as Media Oriented Systems Transport (MOST), Controller Area network (CAN), Local Interconnect Network (LIN), among others.

A “module” and/or “detector”, as used herein, includes, but is not limited to, non-transitory computer readable medium that stores instructions, instructions in execution on a machine, hardware, firmware, software in execution on a machine, and/or combinations of each to perform a function(s) or an action(s), and/or to cause a function or action from another module, method, and/or system. A module and/or detector may also include logic, a software-controlled microprocessor, a discrete logic circuit, an analog circuit, a digital circuit, a programmed logic device, a memory device containing executing instructions, logic gates, a combination of gates, and/or other circuit components. Multiple modules and/or detectors may be combined into one module and/or detector and single modules and/or single detectors may be distributed among multiple modules and/or detectors.

An "operable connection", or a connection by which entities are "operably connected", is one in which signals, physical communications, and/or logical communications may be sent and/or received. An operable connection may include a wireless interface, a physical interface, a data interface, and/or an electrical interface.

A "computer communication", as used herein, refers to a communication between two or more computing devices (e.g., computer, personal digital assistant, cellular telephone, network device) and may be, for example, a network transfer, a file transfer, an applet transfer, an email, a hypertext transfer protocol (HTTP) transfer, and so on. A computer communication may occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

A “vehicle”, as used herein, refers to any moving vehicle that is capable of carrying one or more human occupants and is powered by any form of energy. The term “vehicle” includes cars, trucks, vans, minivans, SUVs, motorcycles, scooters, boats, personal watercraft, and aircraft. In some scenarios, a motor vehicle includes one or more engines. Further, the term "vehicle" may refer to an electric vehicle (EV) that is powered entirely or partially by one or more electric motors powered by an electric battery. The EV may include battery electric vehicles (BEV) and plug-in hybrid electric vehicles (PHEV). Additionally, the term "vehicle" may refer to an autonomous vehicle and/or self-driving vehicle powered by any form of energy.

### SYSTEM OVERVIEW

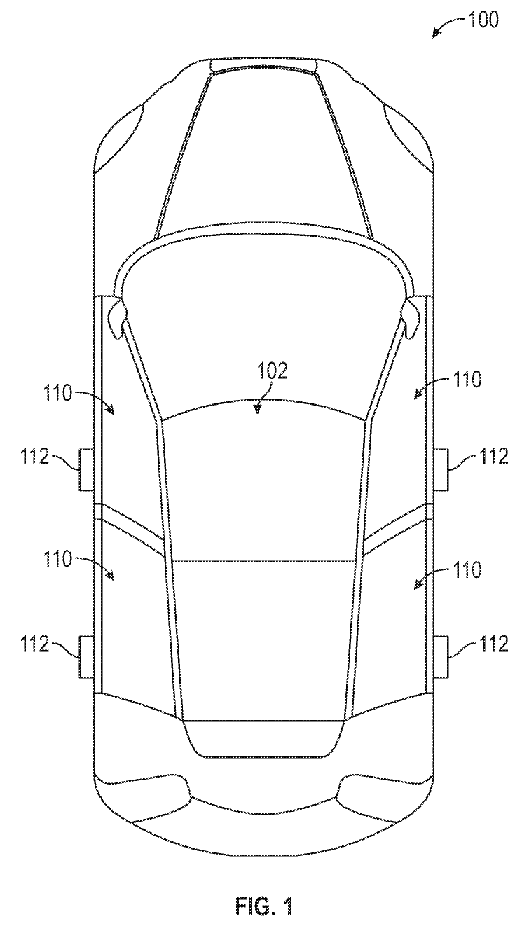

Referring now to the drawings, wherein like numerals refer to like parts throughout the several views, FIG. 1 schematically illustrates a vehicle 100 includes an interior passenger space or cabin 102 configured to accommodate one or more occupants. The vehicle 100 includes one or more doors 110 that allow the occupants to enter into and leave from the cabin 102. Example doors may include a driver side front door, a passenger side front door, one or more rear doors, and/or a tailgate (not shown). In some examples, the doors 110 include one or more door handles 112 for opening and/or closing each of the respective doors 110. Door handles 112 disposed outside the cabin 102 (e.g., “exterior door handles”) may be used to allow one or more passengers to access or enter the cabin 102, and door handles 112 disposed inside the cabin 102 (e.g., “interior door handles”) may be used to allow one or more passengers to exit the cabin 102. In some examples, the doors 110 may be moved between a locked state and an unlocked state. While the cabin 102 is described and shown to include four doors 110 and four door handles 112, one of ordinary skill in the art would understand and appreciate that the vehicle 100 described herein may include any quantity of doors and/or door handles in various arrangements.

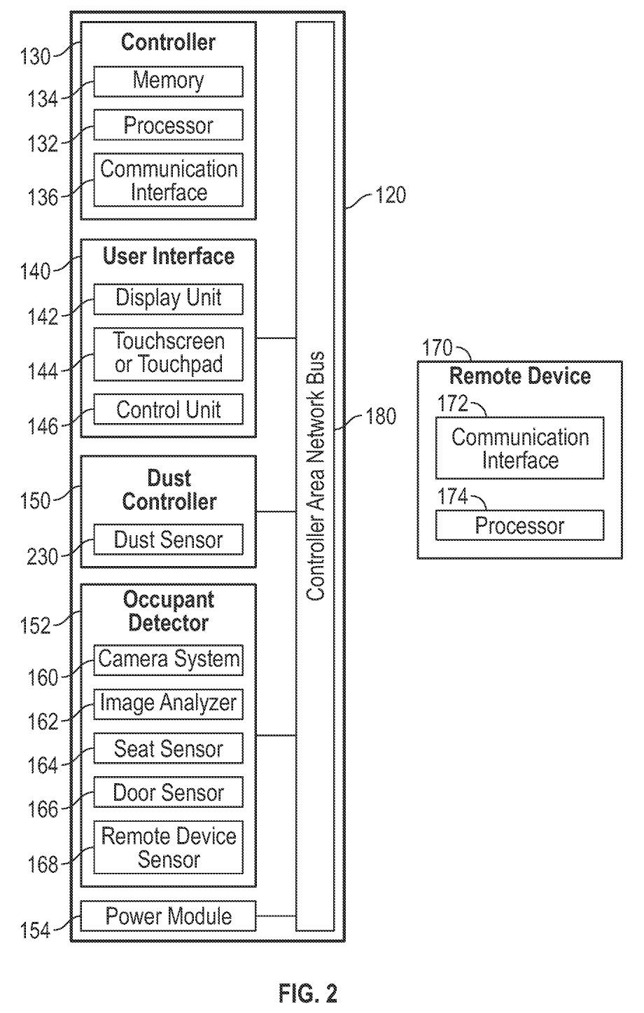

FIG. 2 is an exemplary component diagram of a vehicle system 120, according to one aspect. The vehicle system 120 includes a controller 130. The controller 130 may include a processor 132, a memory 134 and a communication interface 136. The vehicle system 120 includes a user interface 140. The user interface 140 includes a display 142, a touchscreen 144 or touchpad, and a control unit 146. The vehicle system 120 includes a dust controller 150, an occupant detector 152 and a power module 154. It should be appreciated that the dust controller 150 can be part of the processor 132. The occupant detector 152 may include a camera system 160, an image analyzer 162, a seat sensor 164 for each vehicle seat located within the cabin 102, a door sensor 166 for each vehicle door, and a remote device sensor 168 for a remote device 170 used by the operator of the vehicle 100. The remote device 170 may include its own communication interface 172 and a processor 174. The vehicle system 120 may further include a controller area network (CAN) bus 180.

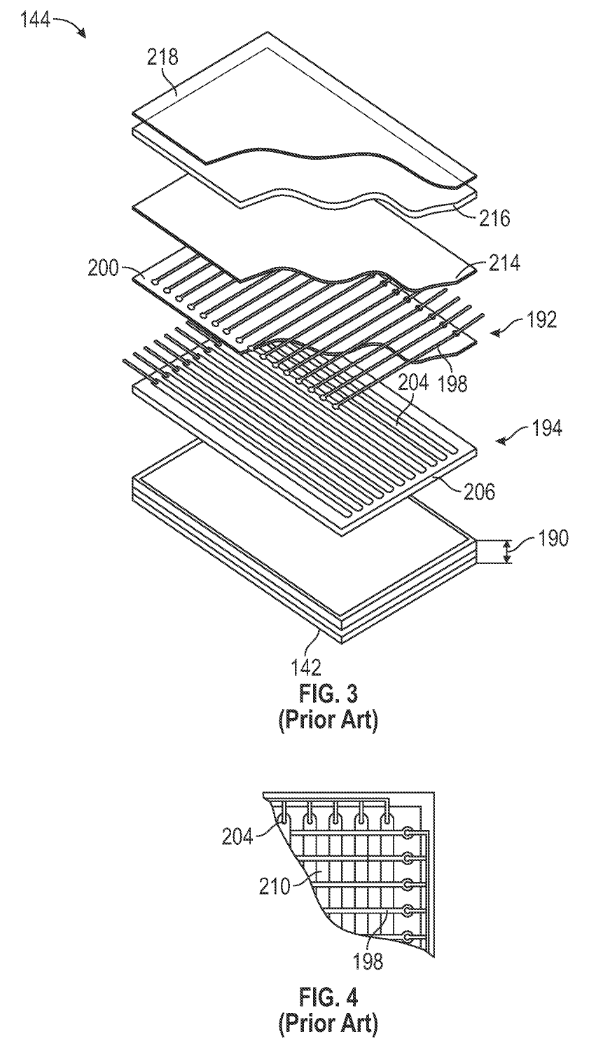

The display unit 142 of the user interface 140 may communicate with the processor 132 via the CAN bus 180 to transmit data to and from the display unit 142, such as for display of various information to the user of the vehicle. In the exemplary aspect, the display unit 142 includes the touchscreen 144. The control unit 146 may be communicatively coupled to the display unit 142. Furthermore, the control unit 146 may be coupled to various other systems of the vehicle. FIG. 3 depicts the display unit 142 with the touchscreen 144 according to a known design. The display unit 142 may be formed by stacked display layers 190, such as liquid crystal display layers, or the like.

The touchscreen panel 144 includes a driving circuit 192 and a sensing circuit 194. The driving circuit 192 includes driving lines 198 formed on or provided on a panel 200, and the sensing circuit 194 includes sensing lines 204 formed on or provided on a glass substrate 206. In the touchscreen 144 of FIG. 4, for example, the sensing lines 204 are arranged in one direction on the substrate 206 and the driving lines 198 are arranged on the panel 200 to cross the sensing lines 204, with an insulating material 210 in the spaces between the driving and sensing lines. It should be appreciated that the number of the driving lines 198 and the number of the sensing lines 204 may be variously changed according to the size and resolution of the touchscreen 144. The driving lines 198 and the sensing lines 204 are configured to form coupling capacitors at crossing points at which the driving lines 198 and the sensing lines 204 cross each other. When touch is generated, since capacitance changes at the position at which the touch has been generated, a current corresponding to the change in the capacitance may be output from a sensing line as a sensing signal. The touchscreen 144 may further include a bonding layer 214 for attaching the panel 200 and a protective cover 216, and a protective anti-reflective coating 218 on an exterior surface of the cover 216. It should be appreciated that alternative configurations for the display unit 142 and the touchscreen 144 are contemplated.

According to the present disclosure, the dust controller 150 is configured to use the layout of the touchscreen 144 to remove dust collected on the cover 216. The dust controller 150 is operably connected to the touchscreen 144 and is configured to apply a first voltage signal having a first polarity to at least one of the driving circuit 192 and the sensing circuit 194 for ionizing dust on the cover 216 of the touchscreen 144. Once the dust is ionized, the dust controller 150 is configured to apply a second voltage signal having a second polarity opposite of the first polarity to at least one of the driving circuit 192 and the sensing circuit 194 to repel the ionized dust from the cover. According to one aspect, the dust controller 150 applies the first voltage signal and the second voltage signal to both the driving circuit 192 and the sensing circuit 194, specifically to both the driving lines 198 and the sensing lines 204 of the respective driving circuit 192 and the sensing circuit 194. According to another aspect, the dust controller 150 applies the first voltage signal to one of the driving circuit 192 and the sensing circuit 194 and applies the second voltage signal to the one of the driving circuit 192 and the sensing circuit 194. According to another aspect, the dust controller 150 applies the first voltage signal to one of the driving circuit 192 and the sensing circuit 194 and applies the second voltage signal to the other of the driving circuit 192 and the sensing circuit 194. The dust controller 150 may include a dust sensor 230 for detecting dust on the cover 216 of the touchscreen 144 and sending a feedback signal when the amount of the dust reaches a first preset value. After receiving the feedback signal, the first voltage is outputted to at least one of the driving circuit 192 and the sensing circuit 194 for a predetermined first period of time to ionize the dust, and then the second voltage having a reverse polarity is outputted to at least one of the driving circuit 192 and the sensing circuit 194 to expel the dust from the cover 216. The dust sensor 230 sends a second feedback signal to stop outputting the second voltage when the amount of the dust reaches a second preset value and/or after a predetermined second period of time.

According to the present disclosure, operation of the dust controller 150 is contingent on whether an occupant is present within the cabin 102 of the vehicle 100. The occupant detector 152 determines whether an occupant is within the vehicle 100. The controller 130 is in communication with the dust controller 150 and the occupant detector 152 via the CAN bus 180, and the controller 130 disables the dust controller 150 upon detection by the occupant detector 152 of an occupant within the vehicle. It should be appreciated that the dust controller 150 may be scheduled to operate at a predetermined time, for example at a set time during the night, ensuring that there is no occupancy within the cabin 102. This scheduling of the dust controller 150 can be via the control unit 146 of the user interface 140.

According to one aspect, the occupant detector 152 includes the camera system 160 configured to capture an image/video of an interior of the cabin 102 and the image analyzer 162 configured to analyze the image/video to determine whether a vehicle seat is occupied. The camera system 160 may be configured to capture one or more images/videos of the cabin 102 including the front seat(s) and the rear seat(s) of the vehicle 100 to thereby determine if one or more front seats and one or more rear seats are occupied or unoccupied. In other words, the camera system 160 is configured to capture images/videos of front seat passenger(s) and rear seat passenger(s) as they are seated within the seat(s). In one embodiment, upon the camera system 160 capturing one or more images/videos, the image analyzer 162 may be configured to execute image logic to determine the presence of the front seat passenger(s) seated within the front seat(s) and/or the rear seat passenger(s) seated within the rear seat(s) of the vehicle 100 at one or more points in time. According to the present disclosure, the controller 130 is configured to disable the dust controller 150 if the image analyzer 162 determines presence of an occupant seated within the cabin 102 of the vehicle 100.

According to one aspect, the occupant detector 152 includes the seat sensor 164 configured to detect an occupancy status of a vehicle seat. The vehicle 100 may include a seat sensor 164 for each vehicle seat (i.e., the front seat(s) and/or the rear seat(s)), and the seat sensor may be configured as load measurement sensors, capacitive sensors, proximity sensors, and the like and may be disposed on one or more sensor pads that may be included within the cushion portion(s) of the vehicle seats. In one embodiment, the seat sensor may be configured to sense when a front seat passenger(s) is seated within the respective front seat(s) and/or a rear seat passenger(s) is seated within the respective rear seat(s) of the vehicle 100.

In one embodiment, the occupant detector 152 may be configured to communicate with the seat sensor 164 disposed within each vehicle seat to receive weight sensor data pertaining to sensed measurements. In one configuration, the seat sensor 164 for each vehicle seat may be configured to provide weight sensor data pertaining to the determination that one or more of the vehicle seats are occupied. The occupant detector 152 may thereby analyze the weight sensor data and determine that one or more vehicle seats are occupied. The controller 130 is in communication with the dust controller 150 and the occupant detector 152, and the controller 130 disables the dust controller upon determination by seat sensor 164 of a passenger seated in one of the vehicle seats.

According to one aspect, the occupant detector 152 includes the door sensor 166 configured to detect whether a vehicle door 110 (for example, the driver’s door) is opened and then closed. The door sensor 166 may be disposed at each of the doors 110 of the vehicle 100, and may be configured to detect the opening, closing, locking, and/or unlocking of each of the respective doors 110 and/or determine a door state of one or more doors 110. Further, the door sensor 166 may be configured to detect or determine whether a door 110 is opened and/or closed using an exterior door handle 112 and/or an interior door handle 112. The door sensor 166 may transmit data indicative of the door state of one or more doors 110 to the controller 130 to be analyzed to determine whether a door 110 is open, closed, locked, and/or unlocked, and/or whether an exterior door handle 112 or interior door handle 112 is used to open and/or close the door 110. According to the present disclosure, the controller 130 is configured to disable the dust controller 150 until it is at least determined that the driver’s door is opened using the interior door handle and then closed with or without use of the exterior door handle. By requiring a determination of the door state of the driver’s door, it may be presumed that the cabin 102 is no longer occupied and that the dust controller 150 may be operated by the controller 130.

According to one aspect, the occupant detector 152 includes the remote device sensor 168 configured to detect whether the remote device 170 that is in communication with the controller 130 is located within the interior of the vehicle 100. The communication interfaces 136, 172 may allow connection of the remote device 170 to the vehicle 100 to allow wireless computer communications utilizing various protocols between components of the remote device 170 and the components of the vehicle 100. The remote device 170 may include a portable device such as a key fob that is pre-associated with the vehicle 100 and/or a mobile device such as a smart phone, a laptop, and/or a tablet. The communication interface 136 and/or the remote device sensor 168 may be configured to determine if the remote device 170 is located within or outside of one or more predetermined distance thresholds of the vehicle 100 based on signals sent to and/or received from the communication interface 172 of the remote device 170. For example, the communication interface 136 and/or the remote device sensor 168 may be configured to determine a signal strength (RSSI) value and/or a time of flight (TOF) value associated with one or more signals communicated by the communication interface 172 of the remote device 170 to determine the presence of the remote device 170 within or outside of the predetermined distance threshold of the vehicle 100. Such a determination may be used by the communication interface 136 and/or the remote device sensor 168 to determine if the remote device 170 is located within or outside of the predetermined distance of the vehicle 100. According to the present disclosure, the controller 130 is configured to disable the dust controller 150 if it is determined that the remote device 170 is located within the cabin 102 of the vehicle.

According to one aspect, the occupant detector 152 includes the power module 154 configured to detect the disabling and/or enabling of an engine of the vehicle 100 and/or determine an engine state of the vehicle 100 (for example, an engine on state and an engine off state). The power module 154 may transmit data via the CAN bus 180 indicative of the engine state of the vehicle 100 to the controller 130 to be analyzed to determine whether the engine of the vehicle 100 is disabled or enabled. The controller 130 is configured to disable the dust controller 150 in the engine on state. It should be appreciated that the power module 154 and the door sensor 166 may work together to determine occupancy of the vehicle 100, with a presumption that the cabin 102 is no longer occupied when it is first determined by the power module 152 that the engine is in the off state, and then determined by the door sensor 166 that the driver’s door was opened using the interior door handle and then closed. According to the present disclosure, the controller 130 is configured to enable the dust controller 150 if it is determined that the engine is in the off state and the driver’s door was opened using the interior door handle and then closed.

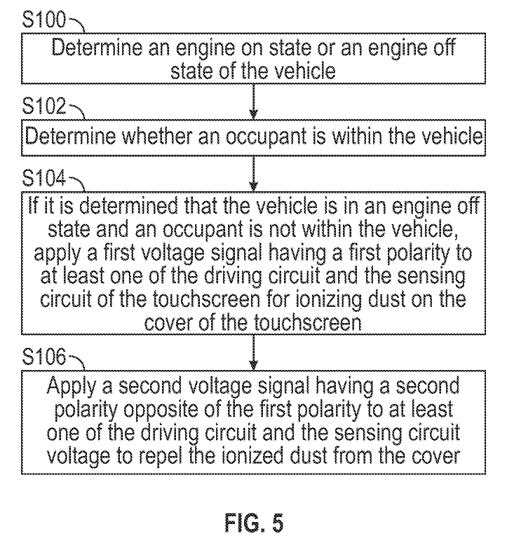

In FIG. 5, a method of removing dust from the touchscreen 144 is provided. The exemplary method comprises in S100 determining an engine on state or an engine off state of the vehicle 100; in S102 determining whether an occupant is within the vehicle 100 via the occupant detector 152 as described above; and if it is determined that an occupant is not within the vehicle, in S104 applying a first voltage signal having a first polarity to at least one of the driving circuit 192 and the sensing circuit 194 for ionizing dust on the cover 216 of the touchscreen 144; and then in S106 applying a second voltage signal having a second polarity opposite of the first polarity to at least one of the driving circuit 192 and the sensing circuit 194 to repel the ionized dust from the cover. The exemplary S102 determining step may include detecting whether a vehicle door is opened and then closed. The exemplary S104 step may include applying the first voltage signal and the second voltage signal to both the driving circuit 192 and the sensing circuit 194. The exemplary S104 step may include applying the first voltage signal to one of the driving circuit 192 and the sensing circuit 194 and applying the second voltage signal to the other of the driving circuit and the sensing circuit.

It will be appreciated that various of the above-disclosed and other features and functions, or alternatives or varieties thereof, may be desirably combined into many other different systems or applications. Also, that various presently unforeseen or unanticipated alternatives, modifications, variations or improvements therein may be subsequently made by those skilled in the art which are also intended to be encompassed by the following claims.

1. A system for removing dust from a touchscreen of a vehicle, the system comprising:
a touchscreen including at least one panel having a driving circuit and a sensing circuit, and a cover covering the at least one panel; and
a dust controller operably connected to the touchscreen for applying a first voltage signal having a first polarity to at least one of the driving circuit and the sensing circuit for ionizing dust on the cover of the touchscreen, and then applying a second voltage signal having a second polarity opposite of the first polarity to at least one of the driving circuit and the sensing circuit to repel the ionized dust from the cover.

2. The system of claim 1, wherein the dust controller applies the first voltage signal and the second voltage signal to both the driving circuit and the sensing circuit.

3. The system of claim 2, wherein the driving circuit includes a plurality of driving lines and the sensing circuit includes a plurality of sensing lines, and the dust controller applies the first voltage signal and the second voltage signal to both the driving lines and the sensing lines.

4. The system of claim 1, wherein the dust controller applies the first voltage signal to one of the driving circuit and the sensing circuit and applies the second voltage signal to the other of the driving circuit and the sensing circuit.

5. The system of claim 1, including an occupant detector for determining whether an occupant is within the vehicle, and a controller in communication with the dust controller and the occupant detector, wherein the controller disables the dust controller upon detection by the occupant detector of an occupant within the vehicle.

6. The system of claim 5, wherein the occupant detector includes a door sensor configured to detect whether a vehicle door is opened and then closed.

7. The system of claim 5, wherein the occupant detector includes a camera configured to capture an image of an interior of the vehicle and an image analyzer configured to analyze the image to determine whether a vehicle seat is occupied.

8. The system of claim 5, wherein the occupant detector includes a seat sensor configured to detect an occupancy status of a vehicle seat.

9. The system of claim 5, wherein the occupant detector includes a remote device sensor configured to detect whether a remote device that is in communication with the controller is located within an interior of the vehicle.

10. The system of claim 1, including power module for determining an engine on state or an engine off state of the vehicle, and a controller in communication with the dust controller and the power module, wherein the controller disables the dust controller in the engine on state.

11. A system for removing dust from a touchscreen of a vehicle, the system comprising:
a touchscreen including at least one panel having a driving circuit and a sensing circuit, and a cover covering the at least one panel;
a dust controller operably connected to the touchscreen for applying a first voltage signal having a first polarity to at least one of the driving circuit and the sensing circuit for ionizing dust on the cover of the touchscreen, and then applying a second voltage signal having a second polarity opposite of the first polarity to at least one of the driving circuit and the sensing circuit to repel the ionized dust from the cover;
an occupant detector for determining whether an occupant is within the vehicle; and
a controller in communication with the dust controller and the occupant detector, wherein the controller disables the dust controller upon detection by the occupant detector of an occupant within the vehicle.

12. The system of claim 11, including power module for determining an engine on state or an engine off state of the vehicle, the controller is in communication with the power module, wherein the controller disables the dust controller in the engine on state.

13. The system of claim 11, wherein the dust controller applies the first voltage signal and the second voltage signal to both the driving circuit and the sensing circuit.

14. The system of claim 11, wherein the dust controller applies the first voltage signal to one of the driving circuit and the sensing circuit and applies the second voltage signal to the other of the driving circuit and the sensing circuit.

15. The system of claim 11, wherein the occupant detector includes a door sensor configured to detect whether a vehicle door is opened and then closed.

16. A method of removing dust from a touchscreen of a vehicle, the touchscreen including at least one panel having a driving circuit and a sensing circuit, and a cover covering the at least one panel, the method comprising:
determining whether an occupant is within the vehicle; and
if it is determined that an occupant is not within the vehicle, applying a first voltage signal having a first polarity to at least one of the driving circuit and the sensing circuit for ionizing dust on the cover of the touchscreen, and then applying a second voltage signal having a second polarity opposite of the first polarity to at least one of the driving circuit and the sensing circuit to repel the ionized dust from the cover.

17. The method of claim 16, wherein prior to applying the first voltage the method includes determining an engine on state or an engine off state of the vehicle, and applying the first voltage in the engine off state.

18. The method of claim 16, wherein the determining step includes detecting whether a vehicle door is opened and then closed.

19. The method of claim 16, including applying the first voltage signal and the second voltage signal to both the driving circuit and the sensing circuit.

20. The method of claim 16, including applying the first voltage signal to one of the driving circuit and the sensing circuit and applying the second voltage signal to the other of the driving circuit and the sensing circuit.
